(19) United States
(12) Patent Application Publication
(10) Pub. No.: US 2025/0315214 A1
(43) Pub. Date: Oct. 9, 2025

(54) LARGE LANGUAGE MODEL AGENT-BASED FRAMEWORK FOR DESIGN REQUIREMENTS ELICITATION

(71) Applicant: AUTODESK, INC., San Francisco, CA (US)

(72) Inventors: Mohammadmehdi ATAEI, Toronto (CA); Hyunmin CHEONG, Toronto (CA); Daniele GRANDI, South Lake Tahoe, CA (US); Ye WANG, Oakland, CA (US); Nigel Jed Wesley MORRIS, Toronto (CA); Alexander TESSIER, Toronto (CA)

(21) Appl. No.: 19/075,309

(22) Filed: Mar. 10, 2025

Related U.S. Application Data
(60) Provisional application No. 63/573,951, filed on Apr. 3, 2024.

(51) Int. Cl. G06F 8/10; G06F 8/20

(52) U.S. Cl. CPC G06F 8/10; G06F 8/20

(57) ABSTRACT

In various embodiments, a computer-implemented method for generating design requirements for a product includes generating an agent based on a design context, where the agent includes a set of characteristics and the design context comprises a description of the product, generating a simulated interaction based on the agent and the design context, where the simulated interaction corresponds to an interaction between the agent and the product, generating an agent interview based on the simulated interaction and a set of interview questions, where the agent interview includes a response to at least one interview question included in the set of interview questions, generating a predicted need based on the agent interview, where the predicted need corresponds to a feature associated with the product, and generating a design requirement based on the predicted need, where the design requirement satisfies the predicted need.

### CROSS-REFERENCE TO RELATED APPLICATIONS

This application claims the benefit of U.S. Provisional Application titled “A LARGE LANGUAGE MODEL AGENT-BASED FRAMEWORK FOR DESIGN REQUIREMENTS ELICITATION,” filed on Apr. 3, 2024, and having Ser. No. 63/573,951. The subject matter of this related application is hereby incorporated herein by reference.

### BACKGROUND

### Field of the Various Embodiments

Embodiments of the present disclosure relate generally to computer science, artificial intelligence, and complex software applications and, more specifically, to a large language model agent-based framework for design requirements elicitation.

### Description of the Related Art

A product design process typically involves several different stages that a design team implements prior to developing a new or updated version of a product. Initially, the design team identifies a set of problems a given target demographic may experience that can potentially be addressed by the new or updated version of the product. The design team then conducts product research on the target demographic to better understand how different individuals experience the identified problems. To conduct product research, the design team may conduct interviews, perform user studies, host focus groups, and hold question-and-answer sessions in order to form a comprehensive assessment of any unmet needs that members of the target demographic experience. Based on this research, the design team generates a set of design requirements that the new or updated version of the product should meet. The set of design requirements can then be used to generate one or more designs for the new or updated version of the product.

One drawback of the approach described above is that identifying members of a particular target demographic can be error-prone and ineffective, especially when the target demographic corresponds to a narrow segment of the population. In some instances, the design team has to manually reach out to individuals who they believe belong to the target demographic and then determine whether those individuals are interested in participating in the various types of research discussed above. This approach generally has a low success rate and often yields smaller and less diverse groups of participants than desired. In other instances, a third-party organization may operate on behalf of the design team to assemble a group of willing participants who belong to the target demographic. However, such an approach does not necessarily yield a larger and more diverse group of participants. As a general matter, with smaller numbers of participants, a design team can have difficulty assessing unmet needs, and oftentimes can experience difficulty in generating design requirements for the new or updated version of the product.

Another drawback of the approach described above is that members of certain demographics can be entirely inaccessible or unavailable, thereby preventing the design team from performing research that involves direct interaction with those members. For example, suppose a design team is developing a new product meant to assist individuals with a specific type of disability, but the nature of that disability prevents those individuals from participating in interviews, user studies, and other forms of direct interaction. In this instance, the design team would not be able to conduct research in the manner described above. Consequently, the design team would be unable to assess unmet needs experienced by the target demographic and would therefore be unable to generate design requirements for the new or updated version of the product.

As the foregoing illustrates, what is needed in the art are more effective techniques for generating design requirements during a product design process.

### SUMMARY

In various embodiments, a computer-implemented method for generating design requirements for a product includes generating an agent based on a design context, where the agent includes a set of characteristics and the design context comprises a description of the product, generating a simulated interaction based on the agent and the design context, where the simulated interaction corresponds to an interaction between the agent and the product, generating an agent interview based on the simulated interaction and a set of interview questions, where the agent interview includes a response to at least one interview question included in the set of interview questions, generating a predicted need based on the agent interview, where the predicted need corresponds to a feature associated with the product, and generating a design requirement based on the predicted need, where the design requirement satisfies the predicted need.

At least one technical advantage of the disclosed techniques relative to the prior art is that the disclosed techniques enable a design team to conduct product research using a large pool of diverse participants that is simulated via LLMs. As a result, the design team need not locate individuals who are willing to participate in product research studies and can therefore generate design requirements more effectively compared to conventional approaches. Another technical advantage of the disclosed techniques is that design teams are able to conduct product research on specific demographics having members that are inaccessible or otherwise unavailable. Accordingly, design teams are better equipped to generate design requirements for niche products meant to serve individuals who cannot participate in product research. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of the various embodiments;

FIG. 2 is a more detailed illustration of the requirements engine of FIG. 1, according to various embodiments;

FIG. 3 is a more detailed illustration of the agent generation stage of FIG. 2, according to various embodiments;

FIG. 4 is a more detailed illustration of the product experience generation stage of FIG. 2, according to various embodiments;

FIG. 5 is a more detailed illustration of the agent interview generation stage of FIG. 2, according to various embodiments;

FIG. 6 is a more detailed illustration of the needs identification stage of FIG. 2, according to various embodiments;

FIG. 7 is a flow diagram of method steps for generating design requirements using agent-based interactions, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

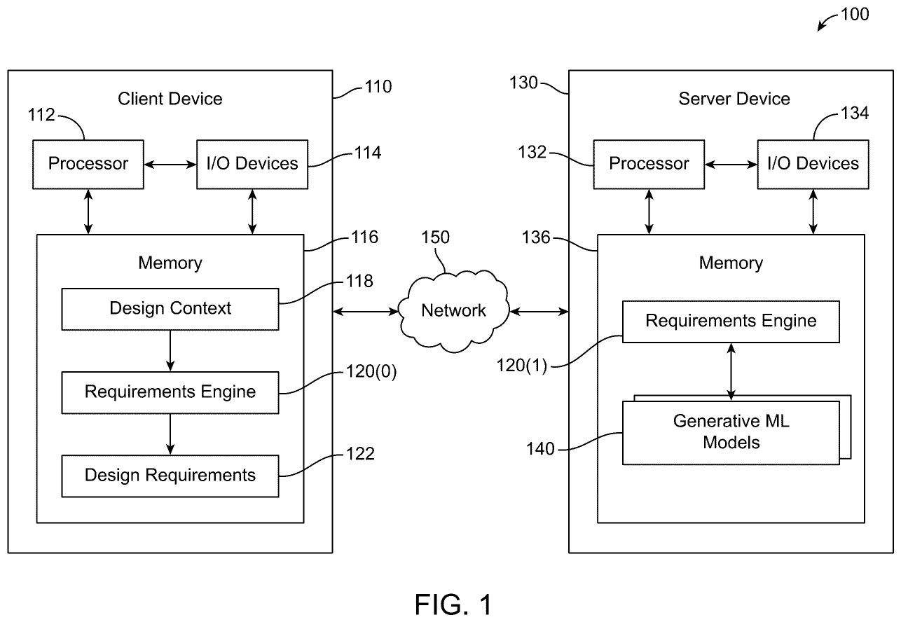

FIG. 1 illustrates a system configured to implement one or more aspects of the various embodiments. As shown, a system 100 includes a client device 110 and a server device 130 coupled together via a network 150. Client device 110 or server device 130 may be any technically feasible type of computer system, including a desktop computer, a laptop computer, a mobile device, a virtualized instance of a computing device, a distributed and/or cloud-based computer system, and so forth. Network 150 may be any technically feasible set of interconnected communication links, including a local area network (LAN), wide area network (WAN), the World Wide Web, or the Internet, among others.

As further shown, client device 110 includes a processor 112, input/output (I/O) devices 114, and a memory 116, coupled together. Processor 112 includes any technically feasible set of hardware units configured to process data and execute software applications. For example, and without limitation, processor 112 could include one or more central processing units (CPUs). I/O devices 114 include any technically feasible set of devices configured to perform input and/or output operations, including, for example and without limitation, a display device, a keyboard, and/or a touchscreen, among others.

Memory 116 includes any technically feasible storage media configured to store data and software applications, such as, for example and without limitation, a hard disk, a random-access memory (RAM) module, and/or a read-only memory (ROM). Memory 116 includes a design context 118, a requirements engine 120(0), and design requirements 122. Design context 118 includes various contextual information pertaining to a potential product that is currently undergoing a design process. For example, and without limitation, design context could include a product category to which the potential product belongs, product specifications associated with the potential product, engineering diagrams of the potential product, and so forth. Design context 118 generally includes any technically feasible type of media, such as text, images, video, computer-aided design (CAD) files, and so forth, for example and without limitation.

Design engine 120(0) is a software application that, when executed by processor 112, interoperates with a corresponding software application executing on server 130 to process design context 118 and generate design requirements 122. Design requirements 122 generally set forth requirements for the potential product currently being designed. Design requirements 122 can specify any technically feasible type of requirement, including, for example and without limitation, functional requirements, aesthetic requirements, physical requirements, form factor requirements, and so forth. Design requirements 122 can include text-based descriptions of various requirements, design constraints associated with one or more CAD designs, three-dimensional (3D) geometry associated with the potential product, and so forth, for example and without limitation.

Server 130 includes a processor 132, I/O devices 134, and a memory 136, coupled together. Processor 132 includes any technically feasible set of hardware units configured to process data and execute software applications, such as one or more CPUs. I/O devices 134 include any technically feasible set of devices configured to perform input and/or output operations, such as, for example and without limitation, a display device, a keyboard, and/or a touchscreen, among others.

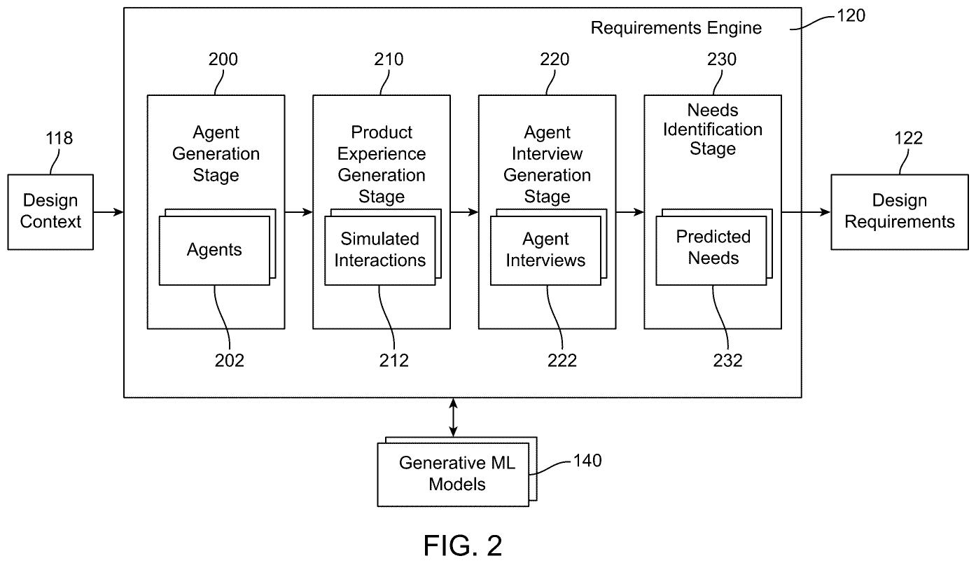

Memory 136 includes any technically feasible storage media configured to store data and software applications, such as, for example and without limitation, a hard disk, a RAM module, and/or a ROM. Memory 136 includes a requirements engine 120(1) and one or more generative machine learning (ML) models 140. Requirements engine 120(1) is a software application that, when executed by processor 132, interoperates with design engine 120(0) executing on client 110 to perform the various operations described above and in greater detail herein. Generative ML models 140 include one or more large-language models (LLMs) trained on vast amounts of data to receive and respond to multi-modal prompts. In one embodiment, generative ML models 140 may be configured to interact with one or more application programming interface (API) endpoints in order to transmit prompts and receive responses from other LLMs located on one or more remote servers. As a general matter, requirements engines 120(0) and 120(1) represent separate portions of a distributed software entity that is configured to perform any and all of the various operations described herein. Thus, for simplicity, requirements engines 120(0) and 120(1) are collectively referred to hereinafter as requirements engine 120. Requirements engine 120 is described in greater detail below in conjunction with FIG. 2.

### Agent-Based Framework for Design Requirements Elicitation

FIG. 2 is a more detailed illustration of the requirements engine of FIG. 1, according to various embodiments. As shown, requirements engine 120 includes a sequence of stages across which requirements engine 120 processes design context 118 to generate design requirements 122. As mentioned above, design context 118 relates to a potential product currently being designed, and design requirements 122 represent requirements for one or more designs associated with the potential product. Requirements engine 120 includes agent generation stage 200, product experience generation stage 210, agent interview generation stage 220, and needs identification stage 230.

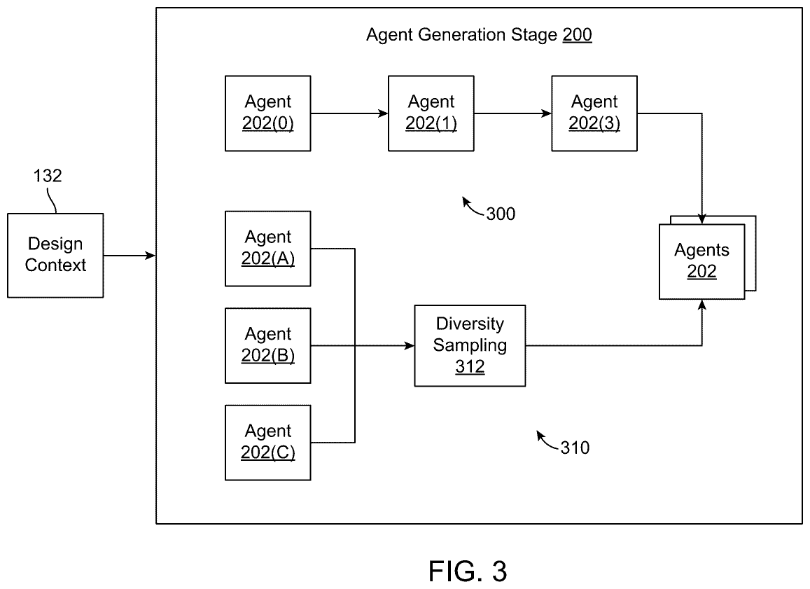

Agent generation stage 200 is configured to implement generative ML models 140 to generate a set of agents 202 based on design context 118. An agent 202 generally represents a simulated product user acting as a participant in a product research study. Agents 202 can belong to one or more target demographics for which the product described in design context 118 is currently being designed. A given agent 202 is defined by a name, a description of various characteristics, and a reasoning chain that explains the rationale behind the generation of that agent 202. Agent generation stage 200 is described in greater detail below in conjunction with FIG. 3.

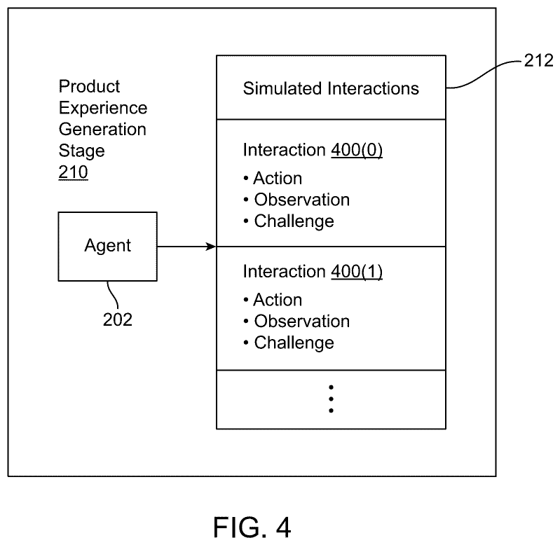

Product experience generation stage 210 is configured to implement generative ML models 140 to generate simulated interactions 212 based on design context 118 and agents 202. Simulated interactions 212 include different sets of simulated interactions 212 for each agent 202. A given simulated interaction 212 is a description of how a corresponding agent 202 could interact with the potential product specified in design context 118, and generally describe an action that could be performed by the agent 202 with the product, an observation that could be made by the agent 202 during the interaction, and a challenge the agent 202 could face in using the product. Product experience generation stage 210 is described in greater detail below in conjunction with FIG. 4.

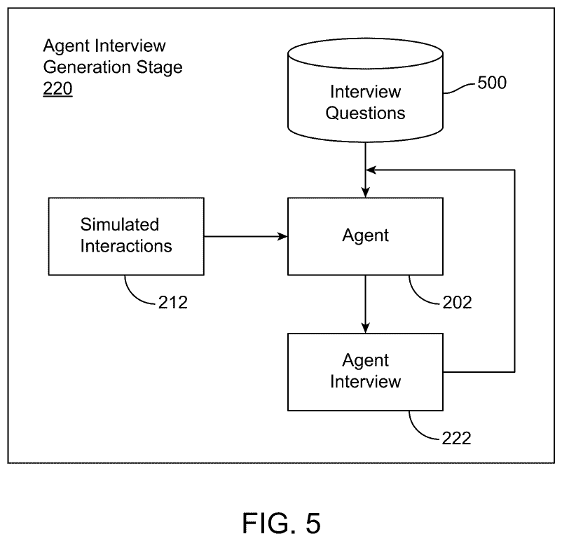

Agent interview generation stage 220 is configured to implement generative ML models 140 to generate agent interviews 222 based on agents 202 and simulated interactions 212. Agent interviews 222 generally include a question and answer session for each agent 202. A given agent interview 222 includes questions derived from a database of interview questions and responses generated for a corresponding agent 202 based on simulated interactions 212. Agent interview generation stage 220 is described in greater detail below in conjunction with FIG. 5.

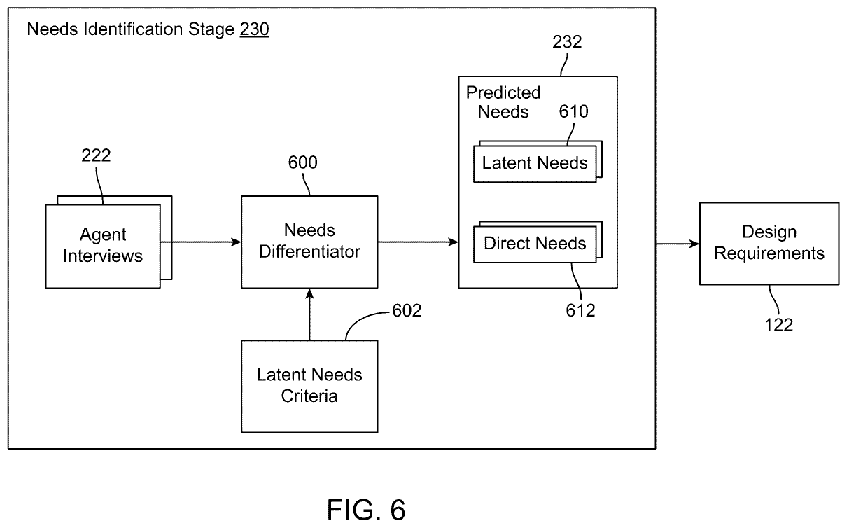

Needs identification stage 230 is configured to implement generative ML models 140 to generate predicted needs 232 based on agent interviews 222. Predicted needs 232 generally represent features, functions, or attributes of the potential product that are determined to be needed based on agent interviews 222. Predicted needs 232 includes different sets of predicted needs for each different agent 202. Further, for a given agent 202, predicted needs 232 can include both direct needs and latent needs. As referred to herein, “direct needs” includes product features that are directly requested by an agent 202 via an agent interview 222, while “latent needs” include non-obvious needs that are not directly requested by an agent 202 via an agent interview 222, as discussed in greater detail herein. Based on predicted needs 232, needs identification stage 230 generates design requirements 122. Needs identification stage 230 is described in greater detail below in conjunction with FIG. 6.

Via the various stages described above, requirements engine 120 is configured to conduct extensive product research for potential products without needing to identify human participants from within a target demographic. Accordingly, the process of generating design requirements can be expedited. Furthermore, design requirements can be generated for target demographics that are difficult to identify, thereby expanding the scope of possible products that can be designed.

FIG. 3 is a more detailed illustration of the agent generation stage of FIG. 2, according to various embodiments. As shown, agent generation stage 200 includes a serial agent generation pipeline 300 and a parallel agent generation pipeline 310. Serial agent generation pipeline 300, as shown, involves the serial generation of agents 202(0), 202(1), and 202(2). Parallel agent generation pipeline 310, on the other hand, involves the parallel generation of agents 202(A), 202(B), and 202(C).

When executing serial agent generation pipeline 300, agent generation stage 200 issues a prompt to generative ML models 140 that causes generative ML models 140 to generate unique descriptions of various characteristics corresponding to different agents 202. Because agents 202 are generated serially, generative ML models 140 can generate agents 202 that are different from agents 202 generated previously. For example, and without limitation, generative ML model 140 could generate agent 202(1) with a different description than that already generated for agent 202(0). This approach helps agent generation stage 200 to generate a diverse pool of agents 202 having unique characteristics.

When executing parallel agent generation pipeline 310, agent generation stage 200 issues multiple prompts to generative ML models 140 in parallel with one another, thereby causing generative ML models 140 to generate various descriptions of agents 202. However, because these prompts are issued in parallel, some agent descriptions may include overlapping characteristics. To address this issue and to enhance the diversity of agents 202, parallel agent generation pipeline 310 implements diversity sampling 312 in order to remove agents 202 having non-diverse, non-unique, or overlapping characteristics. In one embodiment, diversity sampling 310 may generate an embedding vector for each agent 202 within an N-dimensional space, N being an integer value, and may then execute a clustering algorithm in order to partition the N-dimensional space. Based on this partitioning, diversity sampling 312 may then select a representative agent 202 from each cluster and discard the remaining agents.

Agent generation stage 200 can implement serial agent generation pipeline 300, parallel agent generation pipeline 310, or both pipelines in conjunction with one another in order to generate agents 202. When generating a given agent, agent generation stage 200 prompts generative ML models 140 based on design context 118 to generate a description of a user who would use the product being designed. For example, and without limitation, suppose design context 118 describes a tent for use in the extreme conditions found at the North Pole. Agent generation stage 200 would prompt generative ML models 140 to generate descriptions of agents 202 for whom this type of product would be relevant, such as polar bear researchers, climate scientists, and so forth. Similarly, agent generation stage 200 would not generate descriptions of agents 202 for whom this type of product would not be relevant, such as casual outdoor enthusiasts, small children, and so forth. Agent generation stage 200 generates agents 202 via any of the techniques described above and then provides agents 202 to product experience generation stage 210, described below in conjunction with FIG. 4.

FIG. 4 is a more detailed illustration of the product experience generation stage of FIG. 2, according to various embodiments. As shown, product experience generation stage 210 includes an agent 202 configured to generate simulated interactions 212, including interaction 400(0) and interaction 400(1). Each interaction 400 includes an action, an observation, and a challenge. Product experience generation stage 210 generates each interaction 400 by prompting generative ML models 140 using design context 118 and the description that defines the various characteristics of agent 202. Generative ML models 140 can generate any number of interactions 400 for a given agent 202.

An action set forth in a given interaction 400 is a description of a step the agent 202 could take with the potential product described in design context 118. The action could be, for example and without limitation, product setup, feature activation, or disassembly, among others. An observation set forth in a given interaction 400 is a description of reactions and perceptions associated with that action, including favorable impressions and points of friction. A challenge set forth in a given interaction 400 is an articulation of any obstacles or difficulties that could be encountered during the interaction. Product experience generation stage 210 provides simulated interactions 212 to agent interview generation stage 220, described below in conjunction with FIG. 5.

FIG. 5 is a more detailed illustration of the agent interview generation stage of FIG. 2, according to various embodiments. As shown, agent interview generation stage 220 generates agent interview 222 based on agent 202, simulated interactions 212, and interview questions 500. Agent interview 222 represents a question and answer session with agent 202 that explores how agent 202 could have interacted with the potential product, as defined in simulated interactions 212. Agent interview generation stage 220 is configured to prompt generative ML models 140 iteratively by appending sequential interview questions 500 to agent interview 222. In this manner, answers can be generated that integrate prior responses to interview questions 500. In one embodiment, agent interview generation stage 220 may implement generative ML models 140 in order to generate interview questions 500 that probe multiple dimensions of the product experience. Agent interview generation stage 220 provides agent interview 222 to needs identification stage 230, described in greater detail below in conjunction with FIG. 6.

FIG. 6 is a more detailed illustration of the needs identification stage of FIG. 2, according to various embodiments. As shown, needs identification stage 230 includes a needs differentiator 600 that processes agent interviews 222 and latent needs criteria 602 in order to generate predicted needs 232. Predicted needs 232 includes latent needs 610 and direct needs 612. Needs differentiator 600 is configured to prompt generative ML models 140 using agent interviews 222 and latent needs criteria 602 when generating predicted needs 232. As mentioned above in conjunction with FIG. 1, direct needs generally represent features that are directly requested or discussed in a given agent interview 222, whereas latent needs are non-obvious needs and may not have been directly discussed within agent interviews 222. Latent needs criteria 602 generally includes a detailed definition of what constitutes a latent need. In one embodiment, latent needs criteria 602 includes a fixed set of categories related to different aspects of a potential product, and a latent need may be identified as a modification to the product that does not fall into one of those categories. The categories could include, for example and without limitation, size, shape, weight, material, safety, durability, aesthetics, ergonomics, cost, setup, and transport. Based on predicted needs 232, needs identification stage 230 generates design requirements 122. Design requirements 122 reflect, to some degree, each of the different needs set forth in predicted needs 232. Needs identification stage 230 generates design requirements 122 by issuing one or more prompts to generative ML models 140 that include predicted needs 610.

Referring generally to FIGS. 3-6, requirements engine 120 implements the various stages discussed in order to simulate product research performed with a set of participants. These techniques can be applied to generate product requirements for products meant for users who may be difficult to identify and/or locate. Accordingly, the disclosed techniques can significantly improve the product research phase of a design effort.

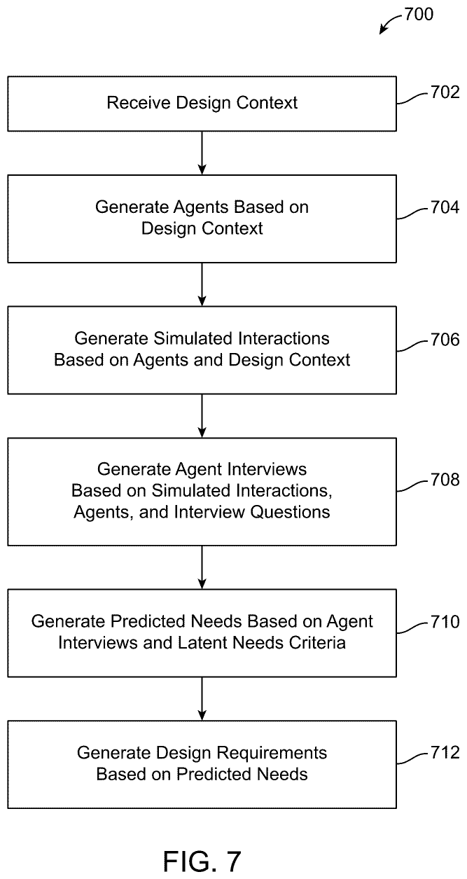

FIG. 7 is a flow diagram of method steps for generating design requirements using agent-based interactions, according to various embodiments. Although the method steps are described in conjunction with the systems of FIGS. 1-7, persons skilled in the art will understand that any system configured to perform the method steps, in any order, is within the scope of the present invention.

As shown, a method 700 begins at step 702, where requirements engine 120 receives design context 118. Design context 118 includes various contextual information pertaining to a potential product that is currently undergoing a design process. For example, and without limitation, design context could include a product category to which the potential product belongs, product specifications associated with the potential product, engineering diagrams of the potential product, and so forth. Design context 118 generally includes any technically feasible type of media, such as text, images, video, CAD files, and so forth, for example and without limitation.

At step 704, agent generation stage 200 within requirements engine 120 generates agents 202 based on design context 118. Agent generation stage 200 can generate agents 202 using serial agent generation pipeline 300 or parallel agent generation pipeline 310. Serial agent generation pipeline 300 implements generative ML models 140 to generate agents 202 sequentially and can therefore generate a diverse pool of agents 202. Parallel agent generation pipeline 310 implements generative ML models 140 to generate different agents 202 independently of one another, and can sometimes generate agents 202 with overlapping characteristics. Diversity sampling 312 within parallel agent generation pipeline 310 is configured to mitigate these issues, thereby allowing parallel agent generation pipeline 310 to also generate a diverse pool of agents 202.

At step 706, product experience generation stage 210 generates simulated interactions 212 based on design context 118 and agents 202. Simulated interactions 212 include one or more interactions 400. Each interaction 400 includes an action, an observation, and a challenge. Product experience generation stage 210 generates each interaction 400 for a given agent 202 by prompting generative ML models 140 using design context 118 and the description that defines the various characteristics of the agent 202. Generative ML models 140 can generate any number of interactions 400 for each agent 202.

At step 708, agent interview generation stage 230 generates agent interviews 222 based on simulated interactions 212 and interview questions 500. A given agent interview 222 represents a question and answer session with agent 202 that explores how agent 202 interacted with the product being designed, as described in simulated interactions 212. In one embodiment, agent interview generation stage 220 may implement generative ML models 140 to generate interview questions 500.

At step 710, needs identification stage 230 generates predicted needs 232 using needs differentiator 600. Predicted needs 232 includes both latent needs 610 and direct needs 612. Needs differentiator 600 can distinguish between latent needs 610 and direct needs 612 based on latent needs criteria 602. Needs differentiator 600 is configured to prompt generative ML models 140 using agent interviews 222 and latent needs criteria 602 when generating predicted needs 232. As a general matter, direct needs represent features that are directly requested or discussed in a given agent interview 222, whereas latent needs are non-obvious needs and may not have been directly discussed within agent interviews 222.

At step 712, needs identification stage 230 generates design requirements 122 based on predicted needs 232. Design requirements 122 specify various functional, physical, an/or aesthetic requirements the product being designed needs to have. In one embodiment, any given design requirement 122 meets at least one need included in predicted needs 232.

In sum, a requirements engine conducts simulated product research using a set of agents in order to generate design requirements for a potential product. The requirements engine includes an agent generation stage, a product experience generation stage, an agent interview generation stage, and a needs identification stage. The requirements engine executes the agent generation stage based on a design context to generate the set of agents. The design context describes high-level attributes of the potential product and/or lower-level features of the potential product. The requirements engine implements a large language model (LLM) to generate a description for each agent based on the design context. A given description represents a set of characteristics associated with a corresponding agent.

The requirements engine then executes the product experience generation stage using the set of agents to generate simulated interactions between the agents and the potential product. Each simulated interaction describes an action that can be taken with the potential product, an observation corresponding to that action, and a challenge associated with that action. The product experience generation stage generates a given simulated interaction based on the set of characteristics associated with a corresponding agent. The requirements engine then executes the agent interview generation stage using the simulated interactions and a database of interview questions to generate a set of agent interviews. Each agent interview includes a series of questions and associated answers related to the corresponding simulated interaction. The agent interview generation stage generates a given agent interview based on the set of characteristics associated with a corresponding agent.

Additionally, the requirements engine executes the needs identification stage with each agent interview to generate a set of predicted needs. The set of predicted needs is differentiated into direct needs explicitly described in the agent interviews and latent needs not explicitly described in the agent interviews. The needs identification stage differentiates between direct needs and latent needs using a set of latent needs criteria. A given predicted need generally corresponds to one or more features or attributes of the potential product. Based on the set of predicted needs collected across all agents, the requirements engine generates a set of design requirements.

At least one technical advantage of the disclosed techniques relative to the prior art is that the disclosed techniques enable a design team to conduct product research using a large pool of diverse participants that is simulated via LLMs. As a result, the design team need not locate individuals who are willing to participate in product research studies and can therefore generate design requirements more effectively compared to conventional approaches. Another technical advantage of the disclosed techniques is that design teams are able to conduct product research on specific demographics having members that are inaccessible or otherwise unavailable. Accordingly, design teams are better equipped to generate design requirements for niche products meant to serve individuals who cannot participate in product research. These technical advantages provide one or more technological advancements over prior art approaches.

1. Various embodiments include a computer-implemented method for generating design requirements for a product, the method comprising generating an agent based on a design context, wherein the agent includes a set of characteristics and the design context comprises a description of the product, generating a simulated interaction based on the agent and the design context, wherein the simulated interaction corresponds to an interaction between the agent and the product, generating an agent interview based on the simulated interaction and a set of interview questions, wherein the agent interview includes a response to at least one interview question included in the set of interview questions, generating a predicted need based on the agent interview, wherein the predicted need corresponds to a feature associated with the product, and generating a design requirement based on the predicted need, wherein the design requirement satisfies the predicted need.

2. The computer-implemented method of clause 1, further comprising causing a generative machine learning model to generate a set of additional agents based on the agent and the design context.

3. The computer-implemented method of any of clauses 1-2, further comprising causing a generative machine learning model to generate a set of additional agents based on the design context and independently from generating the agent, determining at least one agent included in the set of additional agents, wherein the at least one agent includes at least one characteristic included in the set of characteristics, and removing the at least one agent from the set of additional agents.

4. The computer-implemented method of any of clauses 1-3, further comprising causing a generative machine learning model to generate a set of agents that includes the agent, generating a set of embeddings that corresponds to the set of agents, wherein each embedding included in the set of embeddings corresponds to a different agent included in the set of agents, dividing the set of embeddings into a set of partitions via a clustering operation, and selecting a different representative agent from among the set of agents for each partition included in the set of partitions.

5. The computer-implemented method of any of clauses 1-4, wherein generating the simulated interaction comprises causing a generative machine learning model to generate a description of an action that involves the product, causing the generative machine learning model to generate a description of an observation associated with the action, and causing the generative machine learning model to generate a description of a challenge associated with the action.

6. The computer-implemented method of any of clauses 1-5, wherein generating the agent interview comprises causing a generative machine learning model to generate the response to the at least one interview question based on the simulated interaction.

7. The computer-implemented method of any of clauses 1-6, wherein generating the agent interview comprises causing a generative machine learning model to generate the response to the at least one interview question based on the simulated interaction, one or more previous questions, and one or more previous responses.

8. The computer-implemented method of any of clauses 1-7, further comprising causing a generative machine learning model to generate the set of interview questions.

9. The computer-implemented method of any of clauses 1-8, wherein generating the predicted need comprises causing a generative machine learning model to generate the predicted need based on the agent interview and at least one criterion that corresponds to a category of predicted need.

10. The computer-implemented method of any of clauses 1-9, wherein generating the predicted need comprises causing a generative machine learning model to generate the predicted need based on the agent interview and at least one criterion, and further comprising determining that the predicted need meets the at least one criterion, and associating the predicted need with one or more other predicted needs that also satisfy the at least one criterion.

11. Various embodiments include one or more non-transitory computer-readable media including instructions that, when executed by one or more processors, cause the one or more processors to generate design requirements for a product by performing the steps of generating an agent based on a design context, wherein the agent includes a set of characteristics and the design context comprises a description of the product, generating a simulated interaction based on the agent and the design context, wherein the simulated interaction corresponds to an interaction between the agent and the product, generating an agent interview based on the simulated interaction and a set of interview questions, wherein the agent interview includes a response to at least one interview question included in the set of interview questions, generating a predicted need based on the agent interview, wherein the predicted need corresponds to a feature associated with the product, and generating a design requirement based on the predicted need, wherein the design requirement satisfies the predicted need.

12. The one or more non-transitory computer-readable media of clause 11, further comprising the steps of causing a generative machine learning model to generate a set of additional agents based on the design context and independently from generating the agent, determining at least one agent included in the set of additional agents, wherein the at least one agent includes at least one characteristic included in the set of characteristics, and removing the at least one agent from the set of additional agents.

13. The one or more non-transitory computer-readable media of any of clauses 11-12, further comprising the steps of causing a generative machine learning model to generate a set of agents that includes the agent, generating a set of embeddings that corresponds to the set of agents, wherein each embedding included in the set of embeddings corresponds to a different agent included in the set of agents, dividing the set of embeddings into a set of partitions via a clustering operation, and selecting a different representative agent from among the set of agents for each partition included in the set of partitions.

14. The one or more non-transitory computer-readable media of any of clauses 11-13, wherein the step of generating the simulated interaction comprises causing a generative machine learning model to generate a description of an action that involves the product, causing the generative machine learning model to generate a description of an observation associated with the action, and causing the generative machine learning model to generate a description of a challenge associated with the action.

15. The one or more non-transitory computer-readable media of any of clauses 11-14, wherein the step of generating the agent interview comprises causing a generative machine learning model to generate the response to the at least one interview question based on the simulated interaction, one or more previous questions, and one or more previous responses.

16. The one or more non-transitory computer-readable media of any of clauses 11-15, further comprising the step of causing a generative machine learning model to generate the set of interview questions.

17. The one or more non-transitory computer-readable media of any of clauses 11-16, wherein the step of generating the predicted need comprises causing a generative machine learning model to generate the predicted need based on the agent interview and at least one criterion that corresponds to a category of predicted need, and further comprising the steps of determining that the predicted need meets the at least one criterion, and associating the predicted need with one or more other predicted needs that also satisfy the at least one criterion and correspond to the category of predicted need.

18. The one or more non-transitory computer-readable media of any of clauses 11-17, wherein the set of characteristics corresponds to a target demographic associated with the product.

19. The one or more non-transitory computer-readable media of any of clauses 11-18, wherein the design context comprises a multi-modal data set.

20. Various embodiments include a system comprising one or more memories storing instructions, and one or more processors coupled to the one or more memories that, when executing the instructions, perform the steps of generating an agent based on a design context, wherein the agent includes a set of characteristics and the design context comprises a description of a product, generating a simulated interaction based on the agent and the design context, wherein the simulated interaction corresponds to an interaction between the agent and the product, generating an agent interview based on the simulated interaction and a set of interview questions, wherein the agent interview includes a response to at least one interview question included in the set of interview questions, generating a predicted need based on the agent interview, wherein the predicted need corresponds to a feature associated with the product, and generating a design requirement based on the predicted need, wherein the design requirement satisfies the predicted need.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating design requirements for a product, the method comprising:
generating an agent based on a design context, wherein the agent includes a set of characteristics and the design context comprises a description of the product;
generating a simulated interaction based on the agent and the design context, wherein the simulated interaction corresponds to an interaction between the agent and the product;
generating an agent interview based on the simulated interaction and a set of interview questions, wherein the agent interview includes a response to at least one interview question included in the set of interview questions;
generating a predicted need based on the agent interview, wherein the predicted need corresponds to a feature associated with the product; and
generating a design requirement based on the predicted need, wherein the design requirement satisfies the predicted need.

2. The computer-implemented method of claim 1, further comprising causing a generative machine learning model to generate a set of additional agents based on the agent and the design context.

3. The computer-implemented method of claim 1, further comprising:
causing a generative machine learning model to generate a set of additional agents based on the design context and independently from generating the agent;
determining at least one agent included in the set of additional agents, wherein the at least one agent includes at least one characteristic included in the set of characteristics; and
removing the at least one agent from the set of additional agents.

4. The computer-implemented method of claim 1, further comprising:
causing a generative machine learning model to generate a set of agents that includes the agent;
generating a set of embeddings that corresponds to the set of agents, wherein each embedding included in the set of embeddings corresponds to a different agent included in the set of agents;
dividing the set of embeddings into a set of partitions via a clustering operation; and
selecting a different representative agent from among the set of agents for each partition included in the set of partitions.

5. The computer-implemented method of claim 1, wherein generating the simulated interaction comprises:
causing a generative machine learning model to generate a description of an action that involves the product;
causing the generative machine learning model to generate a description of an observation associated with the action; and
causing the generative machine learning model to generate a description of a challenge associated with the action.

6. The computer-implemented method of claim 1, wherein generating the agent interview comprises causing a generative machine learning model to generate the response to the at least one interview question based on the simulated interaction.

7. The computer-implemented method of claim 1, wherein generating the agent interview comprises causing a generative machine learning model to generate the response to the at least one interview question based on the simulated interaction, one or more previous questions, and one or more previous responses.

8. The computer-implemented method of claim 1, further comprising causing a generative machine learning model to generate the set of interview questions.

9. The computer-implemented method of claim 1, wherein generating the predicted need comprises causing a generative machine learning model to generate the predicted need based on the agent interview and at least one criterion that corresponds to a category of predicted need.

10. The computer-implemented method of claim 1, wherein generating the predicted need comprises causing a generative machine learning model to generate the predicted need based on the agent interview and at least one criterion, and further comprising:
determining that the predicted need meets the at least one criterion; and
associating the predicted need with one or more other predicted needs that also satisfy the at least one criterion.

11. One or more non-transitory computer-readable media including instructions that, when executed by one or more processors, cause the one or more processors to generate design requirements for a product by performing the steps of:
generating an agent based on a design context, wherein the agent includes a set of characteristics and the design context comprises a description of the product;
generating a simulated interaction based on the agent and the design context, wherein the simulated interaction corresponds to an interaction between the agent and the product;
generating an agent interview based on the simulated interaction and a set of interview questions, wherein the agent interview includes a response to at least one interview question included in the set of interview questions;
generating a predicted need based on the agent interview, wherein the predicted need corresponds to a feature associated with the product; and
generating a design requirement based on the predicted need, wherein the design requirement satisfies the predicted need.

12. The one or more non-transitory computer-readable media of claim 11, further comprising the steps of:
causing a generative machine learning model to generate a set of additional agents based on the design context and independently from generating the agent;
determining at least one agent included in the set of additional agents, wherein the at least one agent includes at least one characteristic included in the set of characteristics; and
removing the at least one agent from the set of additional agents.

13. The one or more non-transitory computer-readable media of claim 11, further comprising the steps of:
causing a generative machine learning model to generate a set of agents that includes the agent;
generating a set of embeddings that corresponds to the set of agents, wherein each embedding included in the set of embeddings corresponds to a different agent included in the set of agents;
dividing the set of embeddings into a set of partitions via a clustering operation; and
selecting a different representative agent from among the set of agents for each partition included in the set of partitions.

14. The one or more non-transitory computer-readable media of claim 11, wherein the step of generating the simulated interaction comprises:
causing a generative machine learning model to generate a description of an action that involves the product;
causing the generative machine learning model to generate a description of an observation associated with the action; and
causing the generative machine learning model to generate a description of a challenge associated with the action.

15. The one or more non-transitory computer-readable media of claim 11, wherein the step of generating the agent interview comprises causing a generative machine learning model to generate the response to the at least one interview question based on the simulated interaction, one or more previous questions, and one or more previous responses.

16. The one or more non-transitory computer-readable media of claim 11, further comprising the step of causing a generative machine learning model to generate the set of interview questions.

17. The one or more non-transitory computer-readable media of claim 11, wherein the step of generating the predicted need comprises causing a generative machine learning model to generate the predicted need based on the agent interview and at least one criterion that corresponds to a category of predicted need, and further comprising the steps of:
determining that the predicted need meets the at least one criterion; and
associating the predicted need with one or more other predicted needs that also satisfy the at least one criterion and correspond to the category of predicted need.

18. The one or more non-transitory computer-readable media of claim 11, wherein the set of characteristics corresponds to a target demographic associated with the product.

19. The one or more non-transitory computer-readable media of claim 11, wherein the design context comprises a multi-modal data set.

20. A system comprising:
one or more memories storing instructions; and
one or more processors coupled to the one or more memories that, when executing the instructions, perform the steps of:
generating an agent based on a design context, wherein the agent includes a set of characteristics and the design context comprises a description of a product,
generating a simulated interaction based on the agent and the design context, wherein the simulated interaction corresponds to an interaction between the agent and the product,
generating an agent interview based on the simulated interaction and a set of interview questions, wherein the agent interview includes a response to at least one interview question included in the set of interview questions,
generating a predicted need based on the agent interview, wherein the predicted need corresponds to a feature associated with the product, and
generating a design requirement based on the predicted need, wherein the design requirement satisfies the predicted need.
